(19) United States
(12) Patent Application Publication
(10) Pub. No.: US 2024/0124961 A1
(43) Pub. Date: Apr. 18, 2024

(54) REDUCED CARBIDES FERROUS ALLOYS

(71) Applicant: Oerlikon Metco (US) Inc., Westbury, NY (US)

(72) Inventor: Cameron Eibl, La Jolla, CA (US)

(21) Appl. No.: 18/399,370

(22) Filed: Dec. 28, 2023

Related U.S. Application Data
(63) Continuation of application No. 17/042,021, filed on Sep. 25, 2020.
(60) Provisional application No. 62/649,767, filed on Mar. 29, 2018.

(51) Int. Cl. C22C 38/02; B23K 26/342; C22C 38/44; C22C 38/54; C22C 38/58; C23C 4/10; C23C 4/12

(52) U.S. Cl. CPC C22C 38/02; B23K 26/342; C22C 38/44; C22C 38/54; C22C 38/58; C23C 4/10; C23C 4/12; C22C 29/14

(57) ABSTRACT

Disclosed herein are embodiments of wear resistant alloys, such as ferrous alloys, that can have reduced carbide contents. In some embodiments, the alloys may have no carbides. In some, the alloy may have boride phases, such as phases having high Mo+W content and/or high Fe+Cr content. There can be reduced hardphases levels out of the specifically disclosed boride phases in some embodiments. In some embodiments, hypereutectic chromium borides can have limited incorporation into the disclosed alloys.

### CROSS-REFERENCE TO RELATED APPLICATIONS

This application is a continuation application of U.S. patent application Ser. No. 17/042,021, filed Sep. 25, 2020 and entitled “REDUCED CARBIDES FERROUS ALLOYS,” which is a national-phase application of PCT Application No. PCT/US2019/024541, filed Mar. 28, 2019 and entitled “REDUCED CARBIDES FERROUS ALLOYS,” which claims the benefit of U.S. Provisional Application No. 62/649,767, filed Mar. 29, 2018 and entitled “CARBIDE-FREE FERROUS ALLOYS.” The content of each of the above applications is incorporated by reference herein in its entirety.

### BACKGROUND

### Field

The disclosure relates generally to wear resistant ferrous alloys having reduced carbide content.

### Description of the Related Art

Abrasive and erosive wear is a major concern across many industries including mining, oil and gas drilling, mineral processing, concrete and asphalt production, and other applications that involve abrasive media wearing a surface. Applications where wear is an issue typically use wear resistant materials to extend the life of critical components. Wear resistant metal coatings, known as “hardfacing”, bulk cast, or wrought wear resistant alloys are common solutions to these wear problems. Wear resistant alloys typically comprise various borides, carbides, and/or high hardness matrix phases to achieve a desired level of wear resistance while balancing other critical performance metrics such as toughness and cost.

Hardfacing is one example of a manufacturing method which can be used to produce wear resistant parts. However, there is frequently a degree of imprecision in these processes when converting from the feedstock form (e.g., powder, wire, etc.) to the final coating, especially when working with new materials. The imprecision can lead to significant divergence from the desired chemistry, microstructure, thermodynamics, and performance of the resulting material as compared to the original powder, especially with complex alloys. However, while precision is increased with conventional alloys with simple chemistries, they often fail to meet modern performance requirements.

Useful wear resisting or hardbanding alloys can comprise borides, which can increase wear resistance. Boride comprising wear resistant alloys generally fall into two categories: 1) alloys that comprise a single boride phase; and 2) alloys that comprise one or more boride phases with additional carbides.

U.S. Pat. No. 6,171,222, hereby incorporated by reference in its entirety, teaches a wear resistant alloy system that comprises chromium borides in a ferrous matrix. While this system can achieve a wear resistant alloy, it is limited by the maximum hardness achievable by borides that comprise iron and chromium.

U.S. Pat. and Pub. No.'s 2014/0234154, 2015/0354036, U.S. Pat. No. 7,935,198, 2016/0168670, and 2016/0024624, the entirety of each of which is hereby incorporated by reference in its entirety, teach alloys that comprise a combination of hard boride and hard carbide phases that contribute to the wear resistance of the alloys.

### SUMMARY

The present disclosure includes, but is not limited to, the following embodiments.

Embodiment 1: A feedstock material configured to form a microstructure comprising Fe, B: about 1 wt. % to about 3.6 wt. %, C: about 0 wt. % to about 0.5 wt. %, Cr: about 2 wt. % to about 15 wt. %, Mo: about 4 wt. % to about 15 wt. %, Ni: about 0 wt. % to about 3 wt. %, Mn: about 0 wt. % to about 3 wt. %, and Si: about 0 wt. % to about 2 wt. %, wherein the feedstock material configured to form the microstructure comprising a martensitic matrix characterized by having, under thermodynamic equilibrium conditions a mole fraction of complex borides comprising ≥30 wt. % Mo+W, wherein the mole fraction of the complex borides is between about 5 and about 50%, a mole fraction of chromium borides comprising ≥50 wt. % Fe+Cr, wherein the mole fraction of the chromium borides is between about 5 and about 50%, and a mole fraction of hardphases other than the complex borides and the chromium borides of less than about 10%.

Embodiment 2: The feedstock material of Embodiment 1, wherein C: about 0.05 wt. % to about 0.5 wt. %.

Embodiment 3: The feedstock material of Embodiments 1 or 2, wherein the mole fraction of complex borides is between 12.5 and 30.

Embodiment 4: The feedstock material of Embodiments 1-3, wherein the mole fraction of chromium borides is between 12.5 and 30.

Embodiment 5: The feedstock material of Embodiments 1-4, wherein the feedstock material is configured to form the microstructure comprising a mole fraction of hypereutectic hard phases of less than about 10%.

Embodiment 6: The feedstock material of Embodiment 5, wherein the mole fraction of hypereutectic hard phases is less than about 1%.

Embodiment 7: The feedstock material of Embodiments 1-6, wherein the feedstock material is configured to form the microstructure comprising a mole fraction of all hard phases of between about 5% and about 50%.

Embodiment 8: The feedstock material of Embodiment 7, wherein the mole fraction of all hard phases is between about 20% and about 50%.

Embodiment 9: The feedstock material of Embodiment 8, wherein the mole fraction of all hard phases is between about 35% and about 45%.

Embodiment 10: The feedstock material of Embodiments 1-9, wherein the feedstock material is configured to form the microstructure comprising a mole fraction of primary carbides of less than about 1%.

Embodiment 11: The feedstock material of Embodiments 1-10, wherein the mole fraction of hardphases other than the complex borides and the chromium borides is less than about 1%.

Embodiment 12: The feedstock material of Embodiments 1-11, wherein the feedstock material is configured to form microstructure having a martensitic matrix which comprises Fe and is selected from the group consisting of, in wt. %, B: 2.6, C: 0.2, Cr: 10, Mo: 7, B: 2.6, Cr: 8, Mo: 7, B: 2.6, Cr: 8, Mo: 10, B: 2.6, Cr: 6, Mo: 10, B: 2.6, Cr: 4, Mo: 10, B: 2.6, Cr: 2, Mo: 10, B: 3.4, Cr: 5, Mo: 14, B: 2.8, C: 0.2, Cr: 8, Mo: 7, Mn: 1, Si: 0.5, B: 3, C: 0.2, Cr: 6, Mo: 9, Mn: 1, Si: 0.5, B: 3, C: 0.2, Cr: 8, Mo: 7, B: 3, C: 0.2, Cr: 8.7, Mo: 8.3, B: 3.4, C: 0.25, Cr: 9.7, Mo: 9.4, B: 2.8, C: 0.5, Cr: 8, Mo: 7, Mn: 1, Si: 0.5, B: 3, C: 0.5, Cr: 6, Mo: 9, Mn: 1, Si: 0.5, B: 3, C: 0.5, Cr: 8, Mo: 7, B: 3, C: 0.5, Cr: 8.7, Mo: 8.3, B: 3.2, C: 0.5, Cr: 8.7, Mo: 8.3, and B: 3.4, C: 0.5, Cr: 9.7, Mo: 9.4.

Embodiment 13: The feedstock material of any one of Embodiments 1-12, wherein the feedstock material is configured to form the microstructure having a composition of B: about 3, C: about 0.2, Cr: about 8.7, and Mo: about 8.3, or B: about 3.4, C: about 0.25, Cr: about 9.7, and Mo: about 9.4.

Embodiment 14: The feedstock material of any one of Embodiments 1-13, wherein the feedstock material is a powder.

Embodiment 15: The feedstock material of any one of Embodiments 1-14, wherein a composition of the thermal feedstock comprises: B: about 7.5 to about 8.8 wt %, C: about 0.1 to about 1.0 wt %, Cr: about 18 to about 26 wt %, and Mo: about 17 to about 25 wt %

Embodiment 16: A coating formed from the feedstock material of any one of Embodiments 1-15, the coating having a martensitic matrix.

Embodiment 17: The coating of Embodiment 16, wherein the coating has a hardness of at least 59 HRC.

Embodiment 18: The coating of Embodiment 17, wherein the coating has a hardness of at least 65 HRC.

Embodiment 19: The coating of any one of Embodiments 16-18, wherein the coating comprises a volume fraction of complex borides comprising ≥30 wt. % Mo+W, wherein the volume fraction of the complex borides is between about 5 and about 50%, a volume fraction of chromium borides comprising ≥50 wt. % Fe+Cr, wherein the volume fraction of the chromium borides is between about 5 and about 50%, and a volume fraction of hardphases other than the complex borides and the chromium borides of less than about 10%.

Embodiment 20: The coating of Embodiment 19, wherein the volume fraction of complex borides is between 12.5 and 30.

Embodiment 21: The coating of any one of Embodiments 16-20, further comprising a volume fraction of hypereutectic hard phases of less than about 10%.

Embodiment 22: The coating of Embodiment 21, wherein the volume fraction of hypereutectic hard phases is less than about 1%.

Embodiment 23: The coating of any one of Embodiments 16-23, wherein a volume fraction of all hard phases is between about 20% and about 50%.

Embodiment 24: The coating of any one of Embodiments 19-23, wherein the volume fraction of hardphases other than the complex borides and the chromium borides is less than about 1%.

Embodiment 25: The coating of any one of Embodiments 16-24, further comprising a weight percent of carbon in the martensitic matrix of between about 0 and about 0.45 wt. %.

Embodiment 26: The coating of Embodiment 25, wherein the weight percent of carbon in the martensitic matrix is between about 0.2 and about 0.37 wt. %

Embodiment 27: The coating of any one of Embodiments 16-26, further comprising a percent of chromium in the martensitic matrix of between 5 and 12 wt. %.

Embodiment 28: A method of forming a hardfacing coating onto a substrate, the method comprising applying a feedstock material to the substrate to form the coating, the coating comprising Fe, B: about 1 wt. % to about 3.6 wt. %, C: about 0 wt. % to about 0.5 wt. %, Cr: about 2 wt. % to about 15 wt. %, Mo: about 4 wt. % to about 15 wt. %, Ni: about 0 wt. % to about 3 wt. %, Mn: about 0 wt. % to about 3 wt. %, and Si: about 0 wt. % to about 2 wt. %, wherein the feedstock material is configured to form a martensitic matrix which is characterized by having, under thermodynamic equilibrium conditions a mole fraction of complex borides comprising ≥30 wt. % Mo+W, wherein the mole fraction of the complex borides is between about 5 and about 50%, a mole fraction of chromium borides comprising ≥50 wt. % Fe+Cr, wherein the mole fraction of the chromium borides is between about 5 and about 50%, and a mole fraction of hardphases other than the complex borides and the chromium borides of less than about 10%.

Embodiment 29: The method of Embodiment 28, wherein C: about 0.05 wt. % to about 0.5 wt. %.

Embodiment 30: The method of any one of Embodiments 28-29, wherein the applying is a thermal spray.

Embodiment 31: The method of any one of Embodiments 28-29, wherein the applying is a bulk welding process.

Embodiment 32: The method of any one of Embodiments 28-31, wherein the substrate is a wear plate.

Embodiment 33: A wear-resistant dual-boride metallic coating comprising Fe, B: about 1 wt. % to about 3.6 wt. %, C: about 0 wt. % to about 0.5 wt. %, Cr: about 2 wt. % to about 15 wt. %, Mo: about 4 wt. % to about 15 wt. %, Ni: about 0 wt. % to about 3 wt. %, Mn: about 0 wt. % to about 3 wt. %, Si: about 0 wt. % to about 2 wt. %, a martensitic matrix, a volume fraction of complex borides comprising ≥30 wt. % Mo+W, wherein the mole fraction of the complex borides is between about 5 and about 50%, a volume fraction of chromium borides comprising ≥50 wt. % Fe+Cr, wherein the mole fraction of the chromium borides is between about 5 and about 50%, and a volume fraction of hardphases other than the complex borides and the chromium borides of less than about 10%.

Embodiment 34: The coating of Embodiment 33, wherein C: about 0.05 wt. % to about 0.5 wt. %.

Embodiment 35: The coating of Embodiments 33-34, wherein the volume fraction of complex borides is between 12.5 and 30.

Embodiment 36: The coating of any one of Embodiments 33-35, wherein the volume fraction of chromium borides is between 12.5 and 30.

Embodiment 37: The coating of any one of Embodiments 33-36, further comprising a volume fraction of hypereutectic hard phases is less than about 10%.

Embodiment 38: The coating of Embodiment 37, wherein the volume fraction of hypereutectic hard phases is less than about 1%.

Embodiment 39: The coating of any one of Embodiments 33-38, further comprising a volume fraction of all hard phases of between about 5% and about 50%.

Embodiment 40: The coating of Embodiment 39, wherein the volume fraction of all hard phases is between about 20% and about 50%.

Embodiment 41: The coating of Embodiment 39, wherein the volume fraction of all hard phases is between about 35% and about 45%.

Embodiment 42: The coating of any one of Embodiments 33-41, further comprising a volume fraction of primary carbides of less than about 1%.

Embodiment 43: The coating of any one of Embodiments 33-42, further comprising a weight percent of carbon in the martensitic matrix of between about 0 and about 0.45 wt. %.

Embodiment 44: The coating of Embodiment 43, wherein the weight percent of carbon in the martensitic matrix is between about 0.2 and about 0.37 wt. %.

Embodiment 45: The coating of any one of Embodiments 33-44, wherein the volume fraction of hardphases other than the complex borides and the chromium borides is less than about 1%.

Embodiment 46: The coating of any one of Embodiments 33-45, further comprising a percent of chromium in the martensitic matrix of between 5 and 12 wt. %.

Embodiment 47: The coating of any one of Embodiments 33-46, wherein the coating comprises Fe and is selected from the group consisting of, in wt. %, B: 2.6, C: 0.2, Cr: 10, Mo: 7, B: 2.6, Cr: 8, Mo: 7, B: 2.6, Cr: 8, Mo: 10, B: 2.6, Cr: 6, Mo: 10, B: 2.6, Cr: 4, Mo: 10, B: 2.6, Cr: 2, Mo: 10, B: 3.4, Cr: 5, Mo: 14, B: 2.8, C: 0.2, Cr: 8, Mo: 7, Mn: 1, Si: 0.5, B: 3, C: 0.2, Cr: 6, Mo: 9, Mn: 1, Si: 0.5, B: 3, C: 0.2, Cr: 8, Mo: 7, B: 3, C: 0.2, Cr: 8.7, Mo: 8.3, B: 3.4, C: 0.25, Cr: 9.7, Mo: 9.4, B: 2.8, C: 0.5, Cr: 8, Mo: 7, Mn: 1, Si: 0.5, B: 3, C: 0.5, Cr: 6, Mo: 9, Mn: 1, Si: 0.5, B: 3, C: 0.5, Cr: 8, Mo: 7, B: 3, C: 0.5, Cr: 8.7, Mo: 8.3, B: 3.2, C: 0.5, Cr: 8.7, Mo: 8.3, and B: 3.4, C: 0.5, Cr: 9.7, Mo: 9.4.

Embodiment 48: The coating of any one of Embodiments 33-46, wherein a composition of the coating is B: about 3, C: about 0.2, Cr: about 8.7, Mo: about 8.3, or B: about 3.4, C: about 0.25, Cr: about 9.7, and Mo: about 9.4.

Embodiment 49: The coating of any one of Embodiments 33-48, wherein the coating has a hardness of at least 60 HRC.

Embodiment 50: The coating of Embodiment 49, wherein the coating has a hardness of at least 65 HRC.

Embodiment 51: The coating of any one of Embodiments 33-50, wherein the coating is a hardfacing overlay.

Embodiment 52: A powder configured to form the coating of any one of Embodiments 33-51.

Embodiment 53: The powder of Embodiment 52, wherein a composition of the powder is B: about 7.5 to about 8.8 wt %, C: about 0.1 to about 1.0 wt %, Cr: about 18 to about 26 wt %, Mo: about 17 to about 25 wt %

Disclosed herein are embodiments of a ferrous alloy that comprises under equilibrium or near equilibrium solidification conditions at 1300K a mole fraction of borides comprising ≥30 wt. % Mo+W between about 5 and about 50%, a mole fraction of borides comprising ≥50 wt. % Fe+Cr between about 5 and about 50%, and a mole fraction of hardphases with ≥1000 HV other than borides comprising ≥30 wt. % Mo+W and borides comprising ≥50 wt. % Fe+Cr of less than about 10%.

In some embodiments, a mole fraction of hypereutectic hard phases can be less than about 10%. In some embodiments, a mole fraction of all hard phases can be between about 5 and about 50%. In some embodiments, a mole fraction of primary carbides can be less than about 1%. In some embodiments, the matrix can comprise between about 1 and about 25 wt. % chromium. In some embodiments, a weight percent of carbon in the matrix can be between about 0 and about 0.45 wt. %.

In some embodiments, a composition of the alloy can comprise Fe and, in wt. %: B: about 1 to about 3.6; C: about 0 to about 0.5; Cr: about 2 to about 15; Mo: about 4 to about 15; Ni: about 0 to about 3; Mn: about 0 to about 3; and Si: about 0 to about 2.

In some embodiments, the alloy can be a powder. In some embodiments, the alloy can be a melt. In some embodiments, the alloy can be a cored wire having an outer sheath and a powder core. In some embodiments, the alloy can be scrap. In some embodiments the alloy may be an overlay or hardfacing.

Also disclosed herein are embodiments of a dual boride phase ferrous alloy configured to form a wear resistant material having a matrix, the matrix of the wear resistant material comprising Fe and: a volume fraction of borides comprising ≥30 wt. % Mo+W between about 5 and about 50%, a volume fraction of borides comprising ≥50 wt. % Fe+Cr between about 5 and about 50%, and a volume fraction of hardphases with ≥1000 HV other than borides comprising ≥30 wt. % Mo+W and borides comprising ≥50 wt. % Fe+Cr of less than about 10%.

In some embodiments, a volume fraction of hypereutectic borides can be less than about 10%. In some embodiments, a volume fraction of total hard phases can be between about 5 and about 50%. In some embodiments, a volume fraction of carbides can be less than about 1%. In some embodiments, the matrix can comprise between about 1 and about 25 wt. % chromium.

In some embodiments, a composition of the wear resistant material can comprise, in wt. %: B: about 1 to about 3.6; C: about 0 to about 0.5; Cr: about 2 to about 15; Mo: about 4 to about 15; Ni: about 0 to about 3; Mn: about 0 to about 3; and Si: about 0 to about 2.

Further disclosed herein are embodiments of a ferrous alloy comprising Fe and, in wt. %: B: about 1.5 to about 3.6; C: about 0.1 to about 0.5; Cr: about 2 to about 15; and Mo: about 4 to about 12, wherein the ferrous alloy is configured to form a wear resistant material having a dual-phase boride structure.

In some embodiments, the alloy can further comprise, in wt. %: Ni: about 0 to about 3; Mn: about 0 to about 3; and Si: about 0 to about 2.

In some embodiments, the alloy can comprise Fe and, in wt. %: B: 2.6, C: 0.2, Cr: 10, Mo: 7; B: 2.6, Cr: 8, Mo: 7; B: 2.6, Cr: 8, Mo: 10; B: 2.6, Cr: 6, Mo: 10; B: 2.6, Cr: 4, Mo: 10; B: 2.6, Cr: 2, Mo: 10; B: 3.4, Cr: 5, Mo: 14; B: 2.8, C: 0.2, Cr: 8, Mo: 7, Mn: 1, Si: 0.5; B: 3, C: 0.2, Cr: 6, Mo: 9, Mn: 1, Si: 0.5; or B: 3, C: 0.2, Cr: 8, Mo: 7; B: 3, C: 0.2, Cr: 8.7, Mo: 8.3; B: 3.4, C: 0.25, Cr: 9.7, Mo: 9.4.

### BRIEF DESCRIPTION OF THE DRAWINGS

FIG. 1 shows a micrograph of an embodiment of a disclosed alloy (X8).

FIG. 2 shows an equilibrium solidification diagram of an embodiment of an alloy with the composition: B: 2.8, C: 0.2, Cr: 8, Mn: 1, Mo: 7, and Si: 0.5 (X18).

FIG. 3 shows an equilibrium solidification diagram of an alloy which does not meet all criteria disclosed herein with the composition: B: 3.0, C: 0.8, Cr: 8, Mo: 6, and V: 2.

### DETAILED DESCRIPTION

In this disclosure, embodiments of ferrous alloys are described that can include two or more boride phases in addition to a matrix phase without forming carbides from the liquid. Specifically, embodiments of the alloys can comprise iron chromium borides and M₂B and/or M₃B₂ type borides where a substantial portion of M is Mo or W. In some embodiments, a substantial portion is ≥30 wt. % Mo+W (or ≥about 30 wt. % Mo+W).

This can confer several advantages over conventional hardfacing and wear resistant alloy systems. Advantages may include, but are not limited to: 1) not having to balance carbon and a carbide forming element to achieve the desired level of carbon in the ferrous matrix phase; 2) reducing expensive alloying additions such boron carbide, niobium, vanadium, and/or titanium; 3) more wear resistance compared to alloys only comprising iron and/or chromium borides; 4) higher impact performance compared to alloys of similar wear resistance; 5) higher fluidity and weldability due to lower refractory alloy content; and 6) lack of high temperature phases that limit powder manufacture.

In some embodiments, alloys of this disclosure specifically avoid the formation of carbides in the microstructure allowing for easier manufacturability while avoiding the use of expensive carbide formers such as Ti, Nb, Zr, Hf, V. In some embodiments, this disclosure teaches alloys that can have additional boride phases with higher hardness and thus greater wear resistance for a given boride fraction compared to U.S. Pat. No. 6,171,222.

The term alloy can refer to the chemical composition of a powder used to form a metal component (e.g., coating, layer, etc.), the powder itself, the chemical composition of a melt used to form a casting component, the melt itself, and the composition of the metal component formed by the heating, sintering, and/or deposition of the powder, including the composition of the metal component after cooling (such as a coating). In some embodiments, the term alloy can refer to the chemical composition forming the powder disclosed within, the powder itself, the feedstock itself, the wire, the wire including a powder, the combined composition of a combination of wires, the composition of the metal component formed by the heating and/or deposition of the powder, or other methodology, and the metal component.

In some embodiments, alloys manufactured into a solid or cored wire (a sheath containing a powder) for welding or for use as a feedstock for another process may be described by specific chemistries herein. For example, the wires can be used for a thermal spray. Further, the compositions disclosed below can be from a single wire or a combination of multiple wires (such as 2, 3, 4, or 5 wires).

In some embodiments, the alloys can be applied by a thermal spray process to form a thermal spray coating, such as HVOF alloys. In some embodiments, the alloys can be applied as a weld overlay. In some embodiments, the alloys can be applied either as a thermal spray or as a weld overlay, e.g., having dual use.

In some embodiments, wires can be used to form the metal component. For example, pure element powders, ferro alloy powders, and a metallic sheath can be used to achieve a bulk compositions. In some embodiments, casting can be used. Casting can utilize a range of feedstock material, potentially including powders. For example, casting feedstock can include scrap steel, iron, ferro alloys in the form of large pieces, and other pieces of pure elements, thought the particular feedstock is not limiting.

### Metal Alloy Composition

In some embodiments, the alloy can be described by specific compositions, in weight %, and including Fe. In some embodiments, Fe can make the balance of the alloy. In some embodiments, the disclosed compositions may be the feedstock. In some embodiments, the disclosed compositions may be the deposit formed from the feedstock.

In some embodiments, the composition of the alloy can include Fe and, in wt. %:
B: 1 to 3 (or about 1 to about 3)
C: 0 to 0.75 (or about 0 to about 0.75)
Cr: 2 to 15 (or about 2 to about 15)
Mo: 4 to 15 (or about 4 to about 15)
Ni: 0 to 3 (or about 0 to about 3)
Mn: 0 to 3 (or about 0 to about 3)
Si: 0 to 2 (or about 0 to about 2)

In some embodiments, the composition of the alloy can include Fe and, in wt. %:
B: 1 to 3 (or about 1 to about 3)
C: 0.05 to 0.75 (or about 0 to about 0.75)
Cr: 2 to 15 (or about 2 to about 15)
Mo: 4 to 15 (or about 4 to about 15)
Ni: 0 to 3 (or about 0 to about 3)
Mn: 0 to 3 (or about 0 to about 3)
Si: 0 to 2 (or about 0 to about 2)

In some embodiments, the composition of the alloy can include Fe and, in wt. %:
B: 1 to 3 (or about 1 to about 3)
C: 0 to 0.5 (or about 0 to about 0.5)
Cr: 2 to 15 (or about 2 to about 15)
Mo: 4 to 15 (or about 4 to about 15)
Ni: 0 to 3 (or about 0 to about 3)
Mn: 0 to 3 (or about 0 to about 3)
Si: 0 to 2 (or about 0 to about 2)

In some embodiments, the composition of the alloy can include Fe and, in wt. %:
B: 1 to 3 (or about 1 to about 3)
C: 0.05 to 0.5 (or about 0 to about 0.5)
Cr: 2 to 15 (or about 2 to about 15)
Mo: 4 to 15 (or about 4 to about 15)
Ni: 0 to 3 (or about 0 to about 3)
Mn: 0 to 3 (or about 0 to about 3)
Si: 0 to 2 (or about 0 to about 2)

In some embodiments, the composition of the alloy can include Fe and, in wt. %:
B: 1 to 3.6 (or about 1 to about 3.6)
C: 0 to 0.5 (or about 0 to about 0.5)
Cr: 2 to 15 (or about 2 to about 15)
Mo: 4 to 15 (or about 4 to about 15)
Ni: 0 to 3 (or about 0 to about 3)
Mn: 0 to 3 (or about 0 to about 3)
Si: 0 to 2 (or about 0 to about 2)

In some embodiments, the composition of the alloy can include Fe and, in wt. %:
B: 1 to 3.6 (or about 1 to about 3.6)
C: 0.05 to 0.5 (or about 0 to about 0.5)
Cr: 2 to 15 (or about 2 to about 15)
Mo: 4 to 15 (or about 4 to about 15)
Ni: 0 to 3 (or about 0 to about 3)
Mn: 0 to 3 (or about 0 to about 3)
Si: 0 to 2 (or about 0 to about 2)

In some embodiments, the composition of the alloy can include Fe and, in wt. %:
B: 1 to 3 (or about 1 to 3)
C: 0 to 0.5 (or about 0 to 0.5)
Cr: 2 to 15 (or about 2 to 15)
Mo: 4 to 12 (or about 4 to 12)

In some embodiments, the composition of the alloy can include Fe and, in wt. %:
B: 1 to 3 (or about 1 to 3)
C: 0.05 to 0.5 (or about 0 to 0.5)
Cr: 2 to 15 (or about 2 to 15)
Mo: 4 to 12 (or about 4 to 12)

In some embodiments, the composition of the alloy can include Fe and, in wt. %:
B: 1 to 3.6 (or about 1 to 3.6)
C: 0 to 0.5 (or about 0 to 0.5)
Cr: 2 to 15 (or about 2 to 15)
Mo: 4 to 12 (or about 4 to 12)

In some embodiments, the composition of the alloy can include Fe and, in wt. %:
B: 1 to 3.6 (or about 1 to 3.6)
C: 0.05 to 0.5 (or about 0 to 0.5)
Cr: 2 to 15 (or about 2 to 15)
Mo: 4 to 12 (or about 4 to 12)

In some embodiments, the composition of the alloy can also include, in wt. %:
Ni: 0 to 3 (or about 0 to 3)
Mn: 0 to 3 (or about 0 to 3)
Si: 0 to 2 (or about 0 to 2)

In some embodiments, the composition of the alloy can include Fe and, in wt. %:
B: 2 to 3.6 (or about 2 to about 3.6)
C: 0.1 to 0.4 (or about 0.1 to about 0.4)
Cr: 5.5 to 12 (or about 5.5 to about 12)
Mo: 6 to 11 (or about 6 to about 11)

In some embodiments, the composition of the alloy can include Fe and, in wt. %:
B: 2.5 to 3.5 (or about 2.5 to about 3.5)
C: 0.15 to 0.35 (or about 0.15 to about 0.35)
Cr: 6 to 10 (or about 6 to about 10)
Mo: 6 to 10 (or about 6 to about 10)

In some embodiments, the composition of the alloy can include Fe and, in wt. %:
B: 2.6 to 3.4 (or about 2.6 to about 3.4)
C: 0 to 0.5 (or about 0 to about 0.5)
Cr: 5 to 11 (or about 5 to about 11)
Mo: 5 to 11 (or about 5 to about 11)

In some embodiments, the composition of the alloy can include Fe and, in wt. %:
B: 2.6 to 3.4 (or about 2.6 to about 3.4)
C: 0.05 to 0.5 (or about 0 to about 0.5)
Cr: 5 to 11 (or about 5 to about 11)
Mo: 5 to 11 (or about 5 to about 11)

In some embodiments, the composition of the alloy can include Fe and, in wt. %:
B: 7.5 to 8.8 (or about 7.5 to about 8.8)
C: 0.1 to 1.0 (or about 0.1 to about 1.0)
Cr: 18 to 26 (or about 18 to about 26)
Mo: 17 to 25 (or about 17 to about 25)

In some embodiments, the composition of the alloy can include Fe and, in wt. %:
B: 2.6, C: 0.2, Cr: 10, Mo: 7 (or B: about 2.6, C: about 0.2, Cr: about 10, Mo: about 7)
B: 2.6, Cr: 8, Mo: 7 (or B: about 2.6, Cr: about 8, Mo: about 7)
B: 2.6, Cr: 8, Mo: 10 (or B: about 2.6, Cr: about 8, Mo: about 10)
B: 2.6, Cr: 6, Mo: 10 (or B: about 2.6, Cr: about 6, Mo: about 10)
B: 2.6, Cr: 4, Mo: 10 (or B: about 2.6, Cr: about 4, Mo: about 10)
B: 2.6, Cr: 2, Mo: 10 (or B: about 2.6, Cr: about 2, Mo: about 10)
B: 3.4, Cr: 5, Mo: 14 (or B: about 3.4, Cr: about 5, Mo: about 14)
B: 2.8, C: 0.2, Cr: 8, Mo: 7, Mn: 1, Si: 0.5 (or B: about 2.8, C: about 0.2, Cr: about 8, Mo: about 7, Mn: about 1, Si: about 0.5)
B: 3, C: 0.2, Cr: 6, Mo: 9, Mn: 1, Si: 0.5 (or B: about 3, C: about 0.2, Cr: about 6, Mo: about 9, Mn: about 1, Si: about 0.5)
B: 3, C: 0.2, Cr: 8, Mo: 7 (or B: about 3, C: about 0.2, Cr: about 8, Mo: about 7)
B: 3, C: 0.2, Cr: 8.7, Mo: 8.3 (or B: about 3, C: about 0.2, Cr: about 8.7, Mo: about 8.3)
B: 3.2, C: 0.2, Cr: 8.7, Mo: 8.3 (or B: about 3.2, C: about 0.2, Cr: about 8.7, Mo: about 8.3)
B: 3.4, C: 0.25, Cr: 9.7, Mo: 9.4 (or B: about 3.4, C: about 0.25, Cr: about 9.7, Mo: about 9.4)
B: 2.8, C: 0.5, Cr: 8, Mo: 7, Mn: 1, Si: 0.5 (or B: about 2.8, C: about 0.5, Cr: about 8, Mo: about 7, Mn: about 1, Si: about 0.5)
B: 3, C: 0.5, Cr: 6, Mo: 9, Mn: 1, Si: 0.5 (or B: about 3, C: about 0.5, Cr: about 6, Mo: about 9, Mn: about 1, Si: about 0.5)
B: 3, C: 0.5, Cr: 8, Mo: 7 (or B: about 3, C: about 0.5, Cr: about 8, Mo: about 7)
B: 3, C: 0.5, Cr: 8.7, Mo: 8.3 (or B: about 3, C: about 0.5, Cr: about 8.7, Mo: about 8.3)
B: 3.2, C: 0.5, Cr: 8.7, Mo: 8.3 (or B: about 3.2, C: about 0.5, Cr: about 8.7, Mo: about 8.3)
B: 3.4, C: 0.5, Cr: 9.7, Mo: 9.4 (or B: about 3.4, C: about 0.5, Cr: about 9.7, Mo: about 9.4)

In any of the above compositional ranges where C is identified as 0 to X, C may be included within the composition and thus the above formulas can also be recited as 0>C≥X.

Alloys presented in Table 1 have been identified and experimentally manufactured successfully as lab scale ingots. Chemistries in this table represent nominal or target chemistries for a given ingot alloy, and can have the following accuracy ranges: C±0.2; B±0.2; Cr±1; Mo±1; Mn, Ni, and Si±0.5 wt %. These ingots can meet the specific thermodynamic and microstructural embodiments described in this disclosure. Included are Rockwell hardness values measured in HRC, whereas the elements are recited in weight %.

TABLE 1
Alloys meeting the specific thermodynamic and microstructural
criteria of this disclosure made into ingots

| | B | C | Cr | Mn | Mo | Ni | Si | HRC |
|---|---|---|---|---|---|---|---|---|
| P59-X7 | 2.6 | 0.2 | 10 | | 7 | | | 64 |
| P59-X8 | 2.6 | 0 | 8 | | 7 | | | 70 |
| P59-X9 | 2.6 | 0 | 8 | | 10 | | | 68 |
| P59-X10 | 2.6 | 0 | 6 | | 10 | | | 55 |
| P59-X11 | 2.6 | 0 | 4 | | 10 | | | 57 |
| P59-X12 | 2.6 | 0 | 2 | | 10 | | | 55 |
| P59-X13 | 3.4 | 0 | 5 | | 14 | | | 59 |
| P59-X18 | 2.8 | 0.2 | 8 | 1 | 7 | | 0.5 | |
| P59-X19 | 3 | 0.2 | 6 | 1 | 9 | | 0.5 | |
| X21 | 3 | 0.3 | 8.3 | | 7.5 | | | |
| X28 | 3.4 | 0.3 | 11 | | 5 | | | |

Table 2 shows chemistries of a cored wire, such as for use in arc welding, which can form deposits that can meet the specific thermodynamic and microstructural embodiments described in this disclosure. Included are Rockwell hardness values measured in HRC, whereas the elements are recited in weight %. The X18 wire can nominally result in the X18 ingot. Through normal dilution with a steel substrate inherent in various welding processes, the other wires can create compositions that meet the microstructural and thermodynamic embodiments in the rest of the disclosure. The composition can be determined by factoring in the dilution with a mild steel, low alloy steel, or high alloy steel substrate. Different wires below (e.g., X18/X18A/X18B) can produce welds with various amounts of borides and different matrix chemistries that may result in changes in performance. The composition can have the following accuracy ranges: C±0.2; B±0.2; Cr±1; Mo±1; Mn, Ni, and Si±0.5 wt %.

TABLE 2
Feedstock wires where the wire and/or welding deposit meets the specific
thermodynamic and microstructural criteria of this disclosure.

| | B | C | Cr | Mn | Mo | Ni | Si | HRC |
|---|---|---|---|---|---|---|---|---|
| P59-X18 Wire | 4.7 | 0.35 | 13 | 1 | 11.6 | | 0.5 | 65 |
| P59-X18A Wire | 5.4 | 0.4 | 12.5 | 1 | 13.4 | | 0.5 | 67 |
| P59-X18B Wire | 5.3 | 0.5 | 12.5 | 1 | 13.4 | | 0.5 | 66 |

The hardness listed in Table 2 shows the hardness of the weld deposit formed from the wire.

Table 3 shows chemistries of a powder, such as for use in bulk welding, which can form deposits that can meet the specific thermodynamic and microstructural embodiments described in this disclosure. Included are Rockwell hardness values measured in HRC, whereas the elements are recited in weight %. The hardness is measured from a bulk weld deposit of the powder. The powders listed below may form alloys that meet the thermodynamic and microstructural criteria in the rest of this disclosure. The composition can have the following accuracy ranges: C±0.2; B±0.2; Cr±1; Mo±1; Mn, Ni, and Si±0.5 wt %.

TABLE 3
Bulk chemistry of a blended powder used to manufacture alloys
using a bulk welding process that meet the specific thermodynamic
and microstructural criteria of this disclosure.

| | | | | | | | | | Powder |
|---|---|---|---|---|---|---|---|---|---|
| | | | | | | | | | to Wire |
| | B | C | Cr | Mn | Mo | Ni | Si | HRC | Ratio |
| P59-X18 | 8.3 | 0.19 | 23.4 | .4 | 21.77 | | 0.17 | 61 | 1.3:1 |
| Bulk Powder | | | | | | | | | |
| P59-X18A | 8.3 | 0.19 | 23.4 | .4 | 21.77 | | 0.17 | 64 | 1.5:1 |
| Bulk Power | | | | | | | | | |
| P59-X18B | 8.3 | 0.19 | 23.4 | .4 | 21.77 | | 0.17 | 65 | 1.7:1 |
| Bulk Power | | | | | | | | | |
| P59-X18C | 8.3 | 0.19 | 23.4 | .4 | 21.77 | | 0.17 | 65 | 2:1 |
| Bulk Power | | | | | | | | | |

Table 3 shows chemistries of a powder, such as for use different welding techniques, which can form deposits that can meet the specific thermodynamic and microstructural embodiments described in this disclosure. Included are Rockwell hardness values measured in HRC, whereas the elements are recited in weight %. The composition can have the following accuracy ranges: C±0.2; B±0.2; Cr±1; Mo±1; Mn, Ni, and Si±0.5 wt %.

TABLE 4
Atomized powder chemistries where the powder and deposit
produced from said powder using PTA, laser, or other
welding process meets the specific thermodynamic and
microstructural criteria of this disclosure.

| | B | C | Cr | Mn | Mo | Ni | Si | HRC |
|---|---|---|---|---|---|---|---|---|
| P59-X18A Atomized | 3.0 | 0.2 | 8.5 | 1.0 | 7.5 | | 0.5 | 66 |
| Powder | | | | | | | | |

In some embodiments, the alloys can have a hardness greater to or equal to 55 HRC (or about 55 HRC). In some embodiments, the alloys can have a hardness greater to or equal to 60 HRC (or about 60 HRC). In some embodiments, the alloys can have a hardness greater to or equal to 65 HRC (or about 65 HRC). In some embodiments, the alloys can have a hardness greater to or equal to 70 HRC (or about 70 HRC). In some embodiments, the alloys can have a hardness less to or equal to 70 HRC (or about 70 HRC). In some embodiments, the alloys can have a hardness less to or equal to 65 HRC (or about 65 HRC).

The disclosed alloys can incorporate the above elemental constituents to a total of 100 wt. %. In some embodiments, the alloy may include, may be limited to, or may consist essentially of the above named elements. In some embodiments, the alloy may include 2% or less of impurities. Impurities may be understood as elements or compositions that may be included in the alloys due to inclusion in the feedstock components, through introduction in the manufacturing process.

Further, the Fe content identified in all of the compositions described in the above paragraphs may be the balance of the composition as indicated above, or alternatively, the balance of the composition may comprise Fe and other elements. In some embodiments, the balance may consist essentially of Fe and may include incidental impurities. In some embodiments, the compositions can have at least 60 wt. % Fe (or at least about 60 wt. % Fe). In some embodiments, the composition can have between 60 and 80 wt. % Fe (or between about 60 and about 80 wt. % Fe).

### Microstructural Criteria

In some embodiments, alloys of this disclosure may be fully described by microstructural criteria. Alloys can meet some or all of the described microstructural criteria. In some embodiments, a dual-phase boride structure may be formed, which has two types of borides.

The first three microstructural criteria of a dual phase boride structure are: 1) Mo+W complex borides; 2) Fe+Cr borides; and 3) a ferrous matrix with no additional hard phases.

The first microstructural criteria is the volume fraction of borides comprising a given wt. % Mo+W. In some embodiments Mo+W can be ≥30 wt. % (or ≥about 30 wt. %). In some embodiments Mo+W can be ≥35 wt. % (or ≥about 35 wt. %). In some embodiments Mo+W can be ≥40 wt. % (or ≥about 40 wt. %). In some embodiments Mo+W can be ≥45 wt. % (or ≥about 45 wt. %). In some embodiments Mo+W can be ≥50 wt. % (or ≥about 50 wt. %). In some embodiments Mo+W can be ≥55 wt. % (or ≥about 55 wt. %). In some embodiments Mo+W can be ≥60 wt. % (or ≥about 60 wt. %). Mo and W can be interchangeable, and in some embodiments either Mo or W may be 0. These will be known as “complex borides”. This phase typically has the chemical formula M₂B or M₃B₂, where M is a mixture of one or more metallic elements including substantial portions of Mo and/or W. These borides can convey several advantages over typical borides used in wear resistant alloys, including those with a metallic constituent that comprises predominantly iron and/or chromium. For example, complex borides can form a finer grained lamellar eutectic structure, which can lead to increased toughness and wear performance. Complex borides can be extremely hard, often over 2000 HV, which can thereby increase wear resistance for a given hard phase or boride fraction in an alloy. Additionally, the complex boride phases may also be spheroidized or partially spheroidized much more readily than iron and chromium borides. This modification can further increase toughness over conventional alloys allowing for more applications or components using less material.

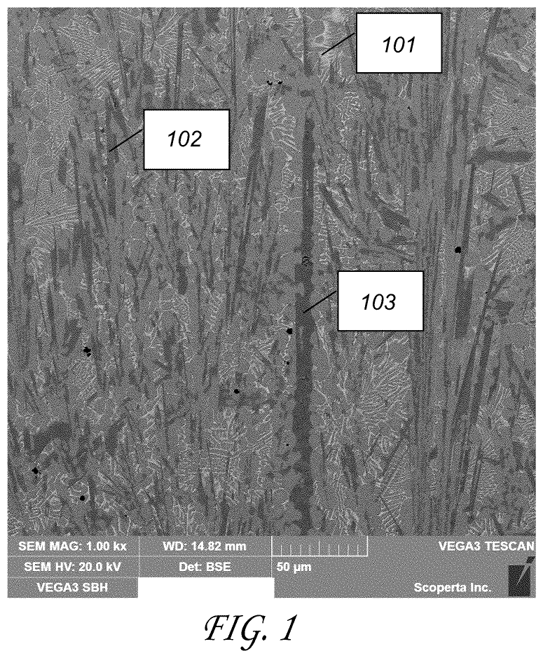

The complex boride volume fraction can be measured using XRD, EBSD, and/or quantitative metallography techniques. In FIG. 1, showing a micrograph of Alloy X8, a complex boride phase is [101]. XRD and/or EBSD can be used to verify the structure of the boride as M₂B or M₃B₂ type. Chemistry of the phase is identified using EDX or similar spectroscopy techniques in a SEM.

The following description is applicable for any of the Mo+W ranges discussed above. In some embodiments, the complex boride volume fraction of the alloy can be between 5 and 50% (or between about 5 and about 50%). In some embodiments, the complex boride volume fraction of the alloy can be between 5 and 35% (or between about 5 and about 35%). In some embodiments, the complex boride volume fraction of the alloy can be between 5 and 30% (or between about 5 and about 30%). In some embodiments, the complex boride volume fraction of the alloy can be between 5 and 20% (or between about 5 to about 20%). In some embodiments, the complex boride volume fraction of the alloy can be between 5 and 15% (or between about 5 to about 15%). In some embodiments, the complex boride volume fraction of the alloy can be between 10 and 15% (or between about 10 to about 15%). In some embodiments, the complex boride volume fraction of the alloy can be between 7.5 and 15% (or between about 7.5 to about 15%). In some embodiments, the complex boride volume fraction of the alloy can be between 10 and 20% (or between about 10 to about 20%). In some embodiments, the complex boride volume fraction of the alloy can be between 10 and 15% (or between about 10 to about 15%). In some embodiments, the complex boride volume fraction of the alloy can be between 10 and 25% (or between about 10 to about 25%). In some embodiments, the complex boride volume fraction of the alloy can be between 12.5 and 30% (or between about 12.5 to about 30%).

The second microstructural criteria is the volume fraction of borides comprising Fe+Cr. In some embodiments Fe+Cr can be ≥40 wt. % (or ≥about 40 wt. %). In some embodiments Fe+Cr can be ≥50 wt. % (or ≥about 50 wt. %). In some embodiments Fe+Cr can be ≥60 wt. % (or ≥about 60 wt. %). In some embodiments Fe+Cr can be ≥70 wt. % (or ≥about 70 wt. %). In some embodiments Fe+Cr can be ≥75 wt. % (or ≥about 75 wt. %). In some embodiments Fe+Cr can be ≥80 wt. % (or ≥about 80 wt. %). In some embodiments, Fe or Cr could be 0. In some embodiments, this criteria could also meet <30% Mo+W (or <about 30% Mo+W). These will be known as “chromium borides”. This phase typically has the chemical formula Cr₂B or M₂B, with M being Fe+Cr. These borides convey several advantages. Chromium borides are readily formed by low cost elements (Cr and Fe) reducing cost of the alloy. Also, chromium and iron are less refractory than W, Mo, Ti, Nb, Hf, Zr, and Ta used to form other hard phases such as borides or carbides. This can improve mixing, weldability, lowers melting temperature, and minimizes the use of less available alloying additions

The chromium boride volume fraction is measured using XRD, EBSD, and/or quantitative metallography techniques. In FIG. 1, this is the phase labeled [102]. XRD and/or EBSD can be used to verify the structure of the boride as M₂B or Cr₂B type. Chemistry of the phase is identified using EDX or similar spectroscopy techniques in a SEM.

The following description is applicable to any of the Fe+Cr ranges discussed above. In some embodiments, the chromium boride volume fraction of the alloy can be between 5 and 50% (or between about 5 and about 50%). In some embodiments, the chromium boride volume fraction of the alloy can be between 5 and 35% (or between about 5 and about 35%). In some embodiments, the chromium boride volume fraction of the alloy can be between 5 and 30% (or between about 5 and about 30%). In some embodiments, the chromium boride volume fraction of the alloy can be between 5 and 20% (or between about 5 and about 20%). In some embodiments, the chromium boride volume fraction of the alloy can be between 5 and 15% (or between about 5 and about 15%). In some embodiments, the chromium boride volume fraction of the alloy can be between 10 and 20% (or between about 10 to about 20%). In some embodiments, the chromium boride volume fraction of the alloy can be between 15 and 25% (or between about 15 to about 25%). In some embodiments, the chromium boride volume fraction of the alloy can be between 20 and 30% (or between about 20 to about 30%). In some embodiments, the chromium boride volume fraction of the alloy can be between 10 and 15% (or between about 10 to about 15%). In some embodiments, the chromium boride volume fraction of the alloy can be between 10 and 25% (or between about 10 to about 25%). In some embodiments, the chromium boride volume fraction of the alloy can be between 12.5 and 30% (or between about 12.5 to about 30%).

The third microstructural criteria is the volume fraction of other hardphases in the alloy where hardphases are defined as phases with ≥1000 HV (or ≥about 1000 HV). These phases may include carbides, borocarbides, intermetallics, and other boride phases not specifically identified in the first two criteria that form from the solid during solidification. Hard phases that precipitate from the solid are specifically excluded from this criteria, such as pearlite, bainite, proeutectoid cementite, and others. Borocarbide phases can be problematic as they typically form an interconnected eutectic structure, minimizing areas of tough matrix critical to impeding crack formation. This can lead to a less impact resistant alloy for a given level of hard phases. Further, embrittling borocarbides can be softer than boride phases leading to reduced wear performance for a given level of alloying with boron. Typically these phases have the formula M₂₃(C,B)₆ where M can be substantially iron and/or chromium.

The volume fraction of other hardphases is measured as the sum of all phases that are not M₂B, M₃B₂, Cr₂B, and iron based matrix phases such as austenite, ferrite, and martensite. M₂B, M₃B₂, Cr₂B may not be stoichiometric so normal variation is allowed for. Hardphases may also be defined as having a hardness of greater than 1000 HV (or greater than about 1000 HV). For example, there may be vacancies in the crystal structure of these phases so the exact chemistry may be something like M_{1.9}B_{1.1}. Also included in the other hardphase criteria are M₂B, M₃B₂, Cr₂B phases where the chemistry does not meet the specific requirements of the first two criteria. This volume fraction is measured using one or more of XRD, EBSD, EDS, and quantitate metallographic techniques. In FIG. 1, the volume fraction of other hardphases is 0%.

In some embodiments, the total volume fraction of other hardphases can be less than 10% (or less than about 10%). In some embodiments, the total volume fraction of other hardphases can be less than 5% (or less than about 5%). In some embodiments, the total volume fraction of other hardphases can be less than 2.5% (or less than about 2.5%). In some embodiments, the total volume fraction of other hardphases can be less than 1% (or less than about 1%). In some embodiments, the total volume fraction of other hardphases can be 0% (or about 0%).

In some embodiments, the total volume fraction of carbides can be less than 10% (or less than about 10%). In some embodiments, the total volume fraction of carbides can be less than 5% (or less than about 5%). In some embodiments, the total volume fraction of carbides can be less than 2.5% (or less than about 2.5%). In some embodiments, the total volume fraction of carbides can be less than 1% (or less than about 1%). In some embodiments, the total volume fraction of carbides can be 0% (or about 0%).

The fourth microstructural criteria is the volume fraction of hypereutectic borides. Hypereutectic complex borides form as blocky near spherical phases with a near 1:1 aspect ratio. Hypereutectic chromium borides can form as long rod shaped phases, typically >100 μm and have a high aspect ratio. These phases can contribute disproportionately to lowering the toughness and impact resistance of the alloy for a given level of wear resistance. Thus it can be advantageous to minimize the volume fraction of these phases.

The volume fraction of hypereutectic borides is measured using quantitative microscopy by one skilled in the art, and is labeled [103] in FIG. 1.

In some embodiments, the hypereutectic boride volume fraction of the alloy can be ≤20% (or ≤about 20%). In some embodiments, the hypereutectic boride volume fraction of the alloy can be ≤15% (or ≤about 15%). In some embodiments, the hypereutectic boride volume fraction of the alloy can be ≤10% (or ≤about 10%). In some embodiments, the hypereutectic boride volume fraction of the alloy can be ≤7.5% (or ≤about 7.5%). In some embodiments, the hypereutectic boride volume fraction of the alloy can be 5% (or ≤about 5%). In some embodiments, the hypereutectic boride volume fraction of the alloy can be ≤2.5% (or ≤about 2.5%). In some embodiments, the hypereutectic boride volume fraction of the alloy can be ≤1% (or ≤about 1%). In some embodiments, the hypereutectic boride volume fraction of the alloy can be 0% (or about 0%).

The fifth microstructural criterion is the volume fraction of carbides that form from the liquid (e.g., primary carbides). In some embodiments, this is the also the volume of all carbides in the final matrix. Eliminating or minimizing the volume fraction of this phase can allow precise control over the microstructural and performance properties of the resulting material. Carbides can confer several disadvantages depending on their specific composition and microstructural morphology. Iron and chromium carbides, such as M₇C₃, are only ˜1600 HV in hardness. Also, they seldom form at equilibrium leaving excess carbon and or chrome remaining in the matrix of the alloy leading to retained austenite or requiring long heat treatment cycles to reach equilibrium. This can lead to reduced wear performance or high processing costs. In the case of the MC carbides, they often form at very high temperatures resulting in reduced fluidity during welding, casting, or other processes. This can pose significant costs to quality of end products using these alloys. Alloys in this disclosure minimize or eliminate the formation of carbides to avoid these issues.

The carbide volume fraction of carbides measured using XRD, EBSD, and/or quantitative metallography techniques. Not included in this definition are carbides precipitated from the solid including those found in pearlitic or bainitic structures, proeutectoid cementite, or other secondary carbides formed from the solid during a heat treatment cycle or during solidification. This non-included carbides may be beneficial to form a bainitic or pearlitic matrix structure.

FIG. 1 shows an alloy with no carbides that form from the liquid.

In some embodiments, the carbide volume fraction of the alloy can be ≤5% (or ≤about 5%). In some embodiments, the carbide volume fraction of the alloy can be ≤3% (or ≤about 3%). In some embodiments, the carbide volume fraction of the alloy can be ≤2% (or ≤about 2%). In some embodiments, the carbide volume fraction of the alloy can be ≤1% (or ≤about 1%). In some embodiments, the carbide volume fraction of the alloy can be ≤0.5% (or ≤about 0.5%). In some embodiments, the carbide volume fraction of the alloy can be ≤0.25% (or ≤about 0.25%). In some embodiments, the carbide volume fraction of the alloy can be ≤0.10% (or ≤about 0.10%). In some embodiments, the carbide volume fraction of the alloy can be 0% (or about 0%).

The sixth microstructural criteria is the total hardphase fraction of the alloy. This is defined as the sum of all borides, carbides, borocarbides, and nitrides. This criteria allows the prediction of the wear resistance of a given alloy as higher hardphase fraction generally leads to improved wear resistance. In FIG. 1, this would be the sum of the complex boride volume fraction [101] and the chromium boride volume fraction [102].

In some embodiments, the total hardphase fraction of the alloy can be between 15 and 55% (or between about 15 and about 55%). In some embodiments, the total hardphase fraction of the alloy can be between 25 and 45% (or between about 25 and about 45%). In some embodiments, the total hardphase fraction of the alloy can be between 35 and 55% (or between about 35 and about 55%). In some embodiments, the total hardphase fraction of the alloy can be between 35 and 45% (or between about 35 and about 45%).

The seventh microstructural criteria is the weight percent of chromium in the ferrous matrix. Chromium is an alloying constituent which can contribute to the corrosion resistance of an alloy in various environments. Having a chromium free or low chromium matrix may be detrimental to the performance of alloys described in this disclosure where corrosion is a significant factor, especially where erosion/corrosion and/or abrasion/corrosion synergies contribute significantly to premature failure of conventional materials. Conversely, excessive chromium can destabilize the austenitic phase during solidification promoting the formation of a ferritic matrix. Ferritic matrices may not be advantageous due to their lower hardness compared to predominantly martensitic and/or bainitic matrices.

In some embodiments, the weight percent of chromium in the matrix can be between 1 and 25 wt. % (or between about 1 and about 25 wt. %). In some embodiments, the weight percent of chromium in the matrix can be between 3 and 20 wt. % (or between about 3 and about 20 wt. %). In some embodiments, the weight percent of chromium in the matrix can be between 5 and 15 wt. % (or between about 5 and about 15 wt. %). In some embodiments, the weight percent of chromium in the matrix can be between 5 and 12 wt. % (or between about 5 and about 12 wt. %).

In some embodiments, the microstructure may be martensite, however the final microstructure may be ferrite, pearlite, austenite, bainite, etc., and the particular final microstructure is not limiting.

### Thermodynamic Criteria

In some embodiments, alloys of this disclosure may be fully described by thermodynamic criteria. Alloys can meet some or all of the described thermodynamic criteria. The thermodynamic criteria can predict the near equilibrium microstructure formed during welding, casting, etc. The microstructure criteria can then drive the performance characteristics of the alloy in some embodiments.

The first three thermodynamic criteria of a dual phase boride structure are: 1) Mole fraction of Mo+W complex borides; 2) Mole fraction of Fe+Cr borides; and 3) a ferrous matrix with no additional hard phases. These thermodynamic characteristics can be strong predictors of the eventual microstructural features when deposited as a weld, cast, or other methods. The calculated and/or measured mole fraction of borides described in the first two criteria can lead to a very similar volume fraction in the resulting microstructure. Avoiding other hard phases as described in criteria three can result in a microstructure that comprises mostly borides of the first two criteria and a ferrous matrix.

Additional thermodynamic criteria can include: 4) hypereutectic boride mole fraction, 5) mole fraction of carbides that form from the liquid, 6) total hardphase mole fraction of the alloy, 7) wt. % chromium in the matrix, 8) percent carbon in the matrix, and 9) difference in formation temperature of two boride phases and liquidus.

Criteria 4 can be an indicator of the toughness of the alloy with higher hypereutectic boride fractions generally reducing toughness. Criteria 5 can predict the phase fraction of carbides that can have microstructural effects that reduce performance. Criteria 6 can be a predictor of wear performance with higher hardphase content generally leading to improved wear performance. Criteria 7 can predict corrosion resistance of the alloy which is important in applications where both abrasion/erosion and corrosion are present. Criteria 8, percent carbon in the ferrous matrix, can also be a predictor of non-advantageous phases during cooling and the eventual hardness of the bulk alloy. Excessive carbon, in the presence of free boron during cooling, can lead to the formation of embrittling borocarbides which significantly limit the toughness of the resulting alloy. Too little carbon on the other hand can impede the formation of sufficiently hard martensite or martensite at all both lowering bulk hardness of the alloy and its eventual wear performance. Criteria 9 can be a strong predictor of a fine microstructural morphology where an alloy that comprises two boride phases that form very close to the liquidus temperature from the liquid during solidification will have a finer structure than an alloy with the same phases present that has a larger difference between formation temperatures and liquidus.

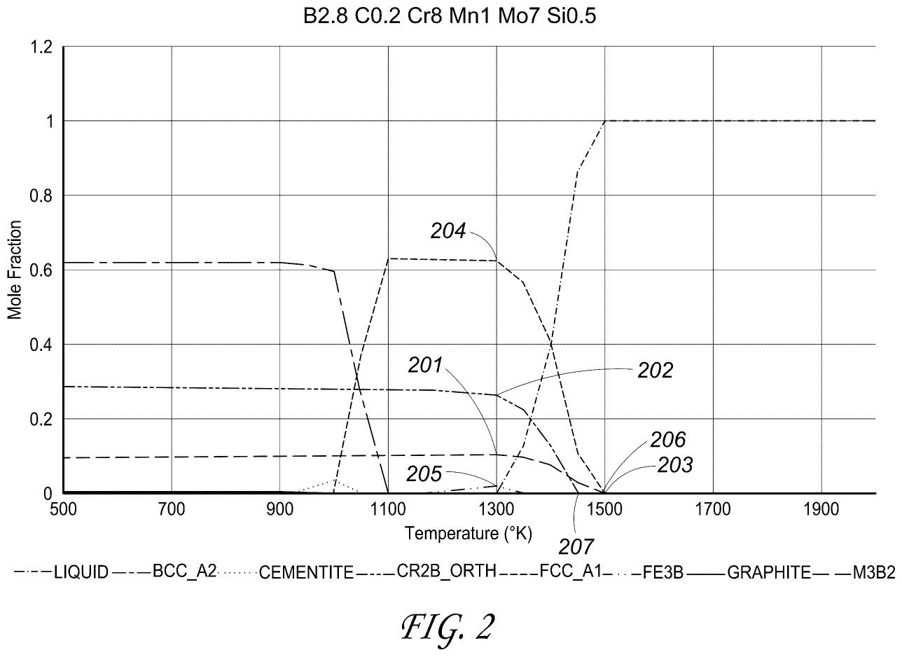

The first thermodynamic criteria is the mole fraction of borides comprising a given wt. % Mo+W. In some embodiments Mo+W can be ≥30 wt. % (or ≥about 30 wt. %). In some embodiments Mo+W can be ≥35 wt. % (or ≥about 35 wt. %). In some embodiments Mo+W can be ≥40 wt. % (or ≥about 40 wt. %). In some embodiments Mo+W can be ≥45 wt. % (or ≥about 45 wt. %). In some embodiments Mo+W can be ≥50 wt. % (or ≥about 50 wt. %). In some embodiments Mo+W can be ≥55 wt. % (or ≥about 55 wt. %). In some embodiments Mo+W can be ≥60 wt. % (or ≥about 60 wt. %). These will be known as “complex borides”. This phase typically has the chemical formula M₂B or M₃B₂ where M is a mixture of one or more metallic elements including ≥30 wt. % Mo and/or W. These borides can convey several advantages over typical borides used in wear resistant alloys including those with a metallic constituent that comprises predominantly iron and/or chromium. Complex borides form a finer grained lamellar eutectic structure leading to increased toughness and wear performance. Complex borides can be substantially harder, often over 2000 HV increasing wear resistance for a given hard phase or boride fraction in an alloy. In FIG. 2, M₃B₂ phase with the predicted chemistry is typically 2000-2200 HV.

The complex boride mole fraction is measured as the sum of all borides meeting the above chemical and structural classification at 1300K during solidification [201], as shown in the phase diagram of Alloy X18 in FIG. 2. In the case of the alloy described by FIG. 2, the chemistry of the M₃B₂ phase comprises 66.9 wt. % Mo+W and the mole fraction of complex boride is measured at 9.9%.

The following description is applicable for any of the Mo+W ranges discussed above. In some embodiments, the complex boride mole fraction of the alloy can be between 5 and 50% (or between about 5 and about 50%). In some embodiments, the complex boride mole fraction of the alloy can be between 5 and 35% (or between about 5 and about 35%). In some embodiments, the complex boride mole fraction of the alloy can be between 5 and 30% (or between about 5 and about 30%). In some embodiments, the complex boride mole fraction of the alloy can be between 5 and 20% (or between about 5 and about 20%). In some embodiments, the complex boride mole fraction of the alloy can be between 5 and 15% (or between about 5 and about 15%). In some embodiments, the complex boride mole fraction of the alloy can be between 10 and 15% (or between about 10 to about 15%). In some embodiments, the complex boride mole fraction of the alloy can be between 7.5 and 15% (or between about 7.5 to about 15%). In some embodiments, the complex boride mole fraction of the alloy can be between 10 and 20% (or between about 10 to about 20%). In some embodiments, the complex boride mole fraction of the alloy can be between 10 and 15% (or between about 10 to about 15%). In some embodiments, the complex boride mole fraction of the alloy can be between 10 and 25% (or between about 10 to about 25%). In some embodiments, the complex boride mole fraction of the alloy can be between 12.5 and 30% (or between about 12.5 to about 30%).

The second thermodynamic criteria is the mole fraction of borides comprising Fe+Cr. In some embodiments Fe+Cr can be ≥40 wt. % (or ≥about 40 wt. %). In some embodiments Fe+Cr can be ≥50 wt. % (or ≥about 50 wt. %). In some embodiments Fe+Cr can be ≥60 wt. % (or ≥about 60 wt. %). In some embodiments Fe+Cr can be ≥70 wt. % (or ≥about 70 wt. %). In some embodiments Fe+Cr can be ≥75 wt. % (or ≥about 75 wt. %). In some embodiments Fe+Cr can be ≥80 wt. % (or ≥about 80 wt. %). These will be known as “chromium borides”. This phase typically has the chemical formula Cr₂B or M₂B. These borides convey several advantages. Chromium borides are readily formed by low cost elements (Cr and Fe) reducing cost of the alloy. Also chromium and iron are less refractory than W, Mo, Ti, Nb, Hf, Zr, and Ta used to form other hard phases such as borides or carbides. This improves mixing, weldability, lowers melting temperature, and minimizes the use of less available alloying additions.

The chromium boride mole fraction is measured during equilibrium solidification conditions at 1300K [202] in FIG. 2. In the case of the alloy described in FIG. 2, the chromium boride chemistry comprises 87 wt. % Fe+Cr and the mole fraction is measured as 26% at 1300K.

The following description is applicable for any of the Fe+Cr ranges discussed above. In some embodiments, the chromium boride mole fraction of the alloy can be between 5 and 50% (or between about 5 and about 50%). In some embodiments, the chromium boride mole fraction of the alloy can be between 5 and 35% (or between about 5 and about 35%). In some embodiments, the chromium boride mole fraction of the alloy can be between 5 and 30% (or between about 5 and about 30%). In some embodiments, the chromium boride mole fraction of the alloy can be between 5% and 20% (or between about 5 and about 20%). In some embodiments, the chromium boride mole fraction of the alloy can be between 5% and 15% (or between about 5 and about 15%). In some embodiments, the chromium boride mole fraction of the alloy can be between 15 and 30% (or between about 15 and about 30%). In some embodiments, the chromium boride mole fraction of the alloy can be between 10 and 20% (or between about 10 to about 20%). In some embodiments, the chromium boride mole fraction of the alloy can be between 15 and 25% (or between about 15 to about 25%). In some embodiments, the chromium boride mole fraction of the alloy can be between 20 and 30% (or between about 20 to about 30%). In some embodiments, the chromium boride mole fraction of the alloy can be between 10 and 15% (or between about 10 to about 15%). In some embodiments, the chromium boride mole fraction of the alloy can be between 10 and 25% (or between about 10 to about 25%). In some embodiments, the chromium boride mole fraction of the alloy can be between 12.5 and 30% (or between about 12.5 to about 30%).

The third thermodynamic criteria is the mole fraction of other hardphases in the alloy where hardphases are defined as phases with ≥1000 HV. These phases may include carbides, borocarbides, intermetallics, and other boride phases not specifically identified in the first two criteria that form from the solid during solidification. Hard phases that precipitate from the solid are specifically excluded from this criteria. Borocarbide phases can form an interconnected eutectic structure minimizing areas of tough matrix to impede crack formation. This can lead to a less impact resistant alloy for a given level of hard phases. Further, embrittling borocarbides can be softer than desirable boride phases leading to reduced wear performance for a given level of alloying with boron. Typically these phases have the formula M₂₃(C,B)₆ where M is substantially iron and/or chromium. Additional hardphases may also include MC type carbides and M₇C₃ type carbides.

The mole fraction of other hardphases is measured as the sum of all phases, that form from the liquid, that are not M₂B, M₃B₂, Cr₂B, and iron based matrix phases such as austenite, ferrite, martensite. M₂B, M₃B₂, Cr₂B may not be stoichiometric so normal variation is allowed for. Also included in the other hardphase criteria are M₂B, M₃B₂, Cr₂B phases where the chemistry does not meet the specific requirements of the first two criteria. This mole fraction is measured at 1300K under equilibrium solidification conditions. In FIG. 2 the only other hardphase present that forms from the liquid is Fe₃B resulting in a mole fraction of other hardphases of 1.9% [205].

In some embodiments, the total mole fraction of other hardphases can be less than 10% (or less than about 10%). In some embodiments, the total mole fraction of other hardphases can be less than 5% (or less than about 5%). In some embodiments, the total mole fraction of other hardphases can be less than 2.5% (or less than about 2.5%). In some embodiments, the total mole fraction of other hardphases can be less than 1% (or less than about 1%). In some embodiments, the total mole fraction of other hardphases can be 0% (or about 0%).

The fourth thermodynamic criteria is the mole fraction of hypereutectic borides. Hypereutectic complex borides form as blocky near spherical phases with a near 1:1 aspect ratio. Hypereutectic chromium borides form as long rod shaped phases, typically >100 μm and have a high aspect ratio. These phases can contribute disproportionately to lowering the toughness and impact resistance of the alloy for a given level of wear resistance. Thus it is often advantageous to minimize the volume fraction of these phases.

The mole fraction of hypereutectic borides is measured as the sum of all borides at the liquidus temperature during equilibrium solidification. In the case of FIG. 2, all borides form at or at a lower temperature than the liquidus [203] resulting in a hypereutectic boride fraction of 0%.

In some embodiments, the hypereutectic boride mole fraction of the alloy can be ≤10% (or ≤about 10%). In some embodiments, the hypereutectic boride mole fraction of the alloy can be ≤7.5% (or ≤about 7.5%). In some embodiments, the hypereutectic boride mole fraction of the alloy can be ≤5% (or ≤about 5%). In some embodiments, the hypereutectic boride mole fraction of the alloy can be ≤2.5% (or ≤about 2.5). In some embodiments, the hypereutectic boride mole fraction of the alloy can be ≤1% (or ≤about 1%). In some embodiments, the hypereutectic boride mole fraction of the alloy can be 0% (or about 0%).

The fifth thermodynamic criterion is the mole fraction of carbides that form from the liquid. Both eutectic and hypereutectic carbides meet this definition. Eliminating or minimizing the mole fraction of this phase allows precise control over the thermodynamic, microstructural, and performance properties of the resulting material. Carbides confer several disadvantages depending on their specific composition and microstructural morphology. Iron and chromium carbides such as the M₇C₃ type are only ˜1600 HV in hardness. Also, they seldom form at equilibrium leaving excess carbon and or chrome remaining in the matrix of the alloy leading to retained austenite or requiring long and expensive heat treatment cycles to reach equilibrium. This can lead to reduced wear performance or high processing costs. In the case of the MC type carbides, they often form at very high temperatures resulting in reduced fluidity during welding, casting, or other processes. This can pose significant costs to quality of end products using these alloys. Alloys in this disclosure minimize or eliminate the formation of carbides to avoid these issues.

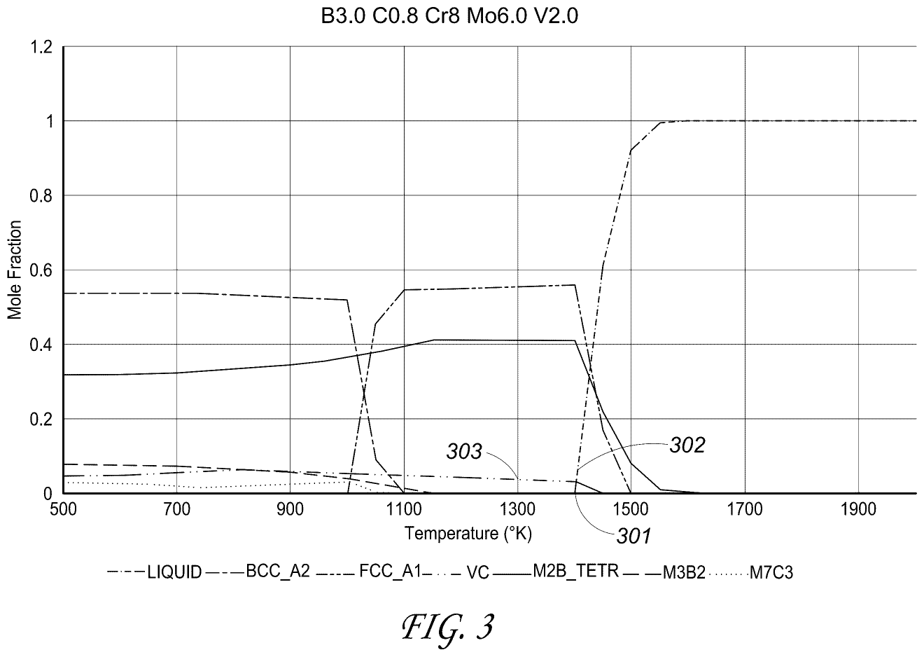

The carbide mole fraction is measured as the sum of all carbides present at the solidus [301] during equilibrium solidification conditions. In the alloy of FIG. 3, which forms carbides from liquids and does not meet the microstructural and thermodynamic criterial discussed herein, this would be measured as the mole faction of VC at the solidus [302] or 3.2%. In the alloy of FIG. 2, there is no carbide phase present at the solidus so the carbide mole fraction is 0%.

In some embodiments the carbide mole fraction of the alloy can be ≤5% (or ≤about 5%). In some embodiments the carbide mole fraction of the alloy can be ≤3% (or ≤about 3%). In some embodiments the carbide mole fraction of the alloy can be ≤2% (or ≤about 2%). In some embodiments the carbide mole fraction of the alloy can be ≤1% (or ≤about 1%). In some embodiments the carbide mole fraction of the alloy can be ≤0.5% (or ≤about 0.5%). In some embodiments the carbide mole fraction of the alloy can be ≤0.25% (or ≤about 0.25%). In some embodiments the carbide mole fraction of the alloy can be ≤0.10% (or ≤about 0.10%). In some embodiments the carbide mole fraction of the alloy can be 0% (or about 0%).

The sixth thermodynamic criteria is the total hardphase fraction of the alloy. This is defined as the sum of all borides, carbides, borocarbides, and nitrides measured under equilibrium solidification conditions at 1300K. This criteria can allow the prediction of the wear resistance of a given alloy as higher hardphase fraction generally leads to improved wear resistance.

In FIG. 2, this is measured as the sum of complex borides [201] 9.9% and chromium borides [202] 26% yielding a total hardphase mole fraction of 35.9%.

In some embodiments, the total hardphase mole fraction of the alloy can be between 15 and 55% (or between about 15 and about 55%). In some embodiments, the total hardphase mole fraction of the alloy can be between 25 and 45% (or between about 25 and about 45%). In some embodiments, the total hardphase mole fraction of the alloy can be between 35 and 55% (or between about 35 and about 55%). In some embodiments, the total hardphase mole fraction of the alloy can be between 35 and 45% (or between about 35 and about 45%).

The seventh thermodynamic criteria is the weight percent of chromium in the ferrous matrix measured at 1300K during equilibrium solidification. Chromium is an alloying constituent which can contribute to the corrosion resistance of an alloy in various environments. Having a chromium free or low chromium matrix may be detrimental to the performance of alloys described in this disclosure where corrosion is a significant factor, especially where erosion/corrosion and/or abrasion/corrosion synergies contribute significantly to premature failure of conventional materials. Conversely, excessive chromium can destabilize the austenitic phase during solidification promoting the formation of a ferritic matrix. Ferritic matrices may be non-advantageous due to their lower hardness compared to predominantly martensitic and/or bainitic matrices.

The weight percent of chromium in the matrix phase is measured at 1300K during equilibrium solidification conditions. In FIG. 2, the matrix phase present is an austenitic FCC phase [204] has 1.5 wt. % chromium.

In some embodiments, the weight percent of chromium in the matrix can be between 1 and 25 wt. % (or between about 1 and about 25 wt. %). In some embodiments, the weight percent of chromium in the matrix can be between 3 and 20 wt. % (or between about 3 and about 20 wt. %). In some embodiments, the weight percent of chromium in the matrix can be between 5 and 15 wt. % (or between about 5 and about 15 wt. %). In some embodiments, the weight percent of chromium in the matrix can be between 5 and 12 wt. % (or between about 5 and about 12 wt. %).

The eighth thermodynamic criteria is the weight percent of carbon in the matrix at 1300K during equilibrium solidification conditions. Controlling the level of carbon in the matrix can be advantageous for several reasons. 1) A high enough level of carbon is necessary to form a sufficiently hard martensitic matrix; 2) Excessive carbon in the matrix may lead to undesirable levels of retained austenite; and 3) Excessive carbon promotes the formation of borocarbide phases in this alloy system that can reduce toughness and impact resistance.

The weight percent of carbon in the matrix phase is measured at 1300K during equilibrium solidification conditions. In FIG. 2, the matrix phase present is an austenitic FCC phase [204] that includes 0.3 wt. % carbon. This could also represent, but does not necessarily define, the carbon % in liquid. The free carbon can occur without forming carbides as the carbon can be soluble in iron solid solution and may also substitute for some of the boron in borides.

In some embodiments, the weight percent of carbon in the matrix can be between 0 and 0.45 wt. % (or between about 0 and about 0.45 wt. %). In some embodiments, the weight percent of carbon in the matrix can be between 0.05 and 0.45 wt. % (or between about 0.05 and about 0.45 wt. %). In some embodiments, the weight percent of carbon in the matrix can be between 0.1 and 0.42 wt. % (or between about 0.1 and about 0.42 wt. %). In some embodiments, the weight percent of carbon in the matrix can be between 0.15 and 0.4 wt. % (or between about 0.15 and about 0.4 wt. %). In some embodiments, the weight percent of carbon in the matrix can be between 0.2 and 0.37 wt. % (or between about 0.2 and about 0.37 wt. %).

An additional thermodynamic criteria, at or near equilibrium solidification conditions, can track the difference between boride formation temperatures and the liquidus. Alloys in this disclosure comprise two crystallographically and chemically distinct borides that form close to the liquidus temperature. This can give a fine grained structure good for wear and impact conditions in service. Specifically excluded from this criteria are formation temperatures of carbides. This criteria is to be known as “boride/liquidus melt range”. Where the first boride to form from the liquid during solidification is “Boride 1” and the second boride to form from the liquid is “Boride 2”.

This criteria can be defined as the maximum difference between each of 2 boride formation temperatures and the liquidus, in absolute value. For example, in the solidification diagram of X18 alloy (FIG. 2), Boride 1 (M₃B₂ formed at about 1500K) formation temperature [206] minus liquidus [203] (0 degK) and Boride 2 (Cr₂B formed at around 1450K) formation temperature [207] minus liquidus [203] (50 degK) would be calculated in absolute value. The maximum value is 50 degK so boride/liquidus melt range would be 50 degK. The FCC matrix can be formed around 1500K. In FIG. 3 no “Boride 2” forms so the value of boride/liquidus melt range is infinite.

In some embodiments the boride/liquidus melt range can be ≤150K (or ≤about 150K). In some embodiments the boride/liquidus melt range can be ≤125K (or ≤about 125K). In some embodiments the boride/liquidus melt range can be ≤100K (or ≤about 100K). In some embodiments the boride/liquidus melt range can be ≤75K (or ≤about 75K). In some embodiments the boride/liquidus melt range can be ≤50K (or ≤about 50K). In some embodiments the boride/liquidus melt range can be ≤25K (or ≤about 25K).

### Applications and Processes for Use:

The alloys described in this patent can be used in a variety of applications and industries. Some non-limiting examples of applications of use include:

Surface mining applications include the following components and coatings for the following components: Wear resistant sleeves and/or wear resistant hardfacing for slurry pipelines, mud pump components including pump housing or impeller or hardfacing for mud pump components, ore feed chute components including chute blocks or hardfacing of chute blocks, separation screens including but not limited to rotary breaker screens, banana screens, and shaker screens, liners for autogenous grinding mills and semi-autogenous grinding mills, ground engaging tools and teeth and hardfacing for ground engaging tools and teeth, shrouds and adapters, wear plate and rock boxes including for buckets and dumptruck liners, heel blocks and hardfacing for heel blocks on mining shovels, grader blades and hardfacing for grader blades, stacker reclaimers, sizer crushers, jaw crushers, ripper teeth, cutting edges, general wear packages for mining components and other comminution components.

Downstream oil and gas applications include the following components and coatings for the following components: Downhole casing and downhole casing, drill pipe and coatings for drill pipe including hardbanding, mud management components, mud motors, fracking pump sleeves, fracking impellers, fracking blender pumps, stop collars, drill bits and drill bit components, directional drilling equipment and coatings for directional drilling equipment including stabilizers and centralizers, blow out preventers and coatings for blow out preventers and blow out preventer components including the shear rams, oil country tubular goods and coatings for oil country tubular goods.

Upstream oil and gas applications include the following components and coatings for the following components: Process vessels and coating for process vessels including steam generation equipment, amine vessels, distillation towers, cyclones, catalytic crackers, general refinery piping, corrosion under insulation protection, sulfur recovery units, convection hoods, sour stripper lines, scrubbers, hydrocarbon drums, and other refinery equipment and vessels.

Pulp and paper applications include the following components and coatings for the following components: Rolls used in paper machines including yankee dryers, through air dryers, and other dryers, calendar rolls, machine rolls, press rolls, winding rolls, digesters, pulp mixers, pulpers, pumps, boilers, shredders, tissue machines, roll and bale handling machines, fiber guidance systems such as deflector blades, doctor blades, evaporators, pulp mills, head boxes, wire parts, press parts, M.G. cylinders, pope reels, winders, vacuum pumps, deflakers, and other pulp and paper equipment,

Power generation applications include the following components and coatings for the following components: boiler tubes, precipitators, fireboxes, turbines, generators, cooling towers, condensers, chutes and troughs, augers, bag houses, ducts, ID fans, coal piping, and other power generation components.

Agriculture applications include the following components and coatings for the following components: chutes, base cutter blades, sugar cane harvesting knives, hammers, troughs, primary fan blades, secondary fan blades, augers, components common to mining applications, and other agricultural applications.

Construction applications include the following components and coatings for the following components: cement chutes, cement piping, bag houses, mixing equipment and other construction applications

Machine element applications include the following components and coatings for the following components: Shaft journals, hydraulic cylinders, paper rolls, gear boxes, drive rollers, impellers, rebuilding of engine decks, propeller shafts and other shafts, general reclamation and dimensional restoration applications and other machine element applications

Steel applications include the following components and coatings for the following components: cold rolling mills, hot rolling mills, wire rod mills, galvanizing lines, continue pickling lines, continuous casting rolls and other steel mill rolls, and other steel applications.

The alloys described in this patent can be produced and or deposited in a variety of techniques effectively. Some non-limiting examples of processes include:
Thermal spray process including those using a wire feedstock such as twin wire arc, spray, high velocity arc spray, combustion spray and those using a powder feedstock such as high velocity oxygen fuel, high velocity air spray, plasma spray, detonation gun spray, and cold spray. Wire feedstock can be in the form of a metal core wire, solid wire, or flux core wire. Powder feedstock can be either a single homogenous alloy or a combination of multiple alloy powder which result in the desired chemistry when melted together.

Welding processes including those using a wire feedstock including but not limited to metal inert gas (MIG) welding, tungsten inert gas (TIG) welding, arc welding, submerged arc welding, open arc welding, bulk welding, laser cladding, and those using a powder feedstock including but not limited to laser cladding and plasma transferred arc welding. Wire feedstock can be in the form of a metal core wire, solid wire, or flux core wire. Powder feedstock can be either a single homogenous alloy or a combination of multiple alloy powder which result in the desired chemistry when melted together.

Casting processes including processes typical to producing cast iron including but not limited to sand casting, permanent mold casting, chill casting, investment casting, lost foam casting, die casting, centrifugal casting, glass casting, slip casting and process typical to producing wrought steel products including continuous casting processes.

Post processing techniques including but not limited to rolling, forging, surface treatments such as carburizing, nitriding, carbonitriding, heat treatments including but not limited to austenitizing, normalizing, annealing, stress relieving, tempering, aging, quenching, cryogenic treatments, flame hardening, induction hardening, differential hardening, case hardening, decarburization, machining, grinding, cold working, work hardening, and welding

From the foregoing description, it will be appreciated that inventive products and approaches for reduced carbide ferrous alloys are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

Some embodiments have been described in connection with the accompanying drawings. The figures are drawn to scale, but such scale should not be limiting, since dimensions and proportions other than what are shown are contemplated and are within the scope of the disclosed inventions. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

1. (canceled)

2. A feedstock material, comprising:
Fe;
B: about 7.5 wt. % to about 8.8 wt. %;
C: about 0.1 wt. % to about 1.0 wt. %;
Cr: about 18 wt. % to about 26 wt. %; and
Mo: about 17 wt. % to about 25 wt. %;
wherein the feedstock material is configured to form a coating on a substrate, the coating comprising:
a martensitic matrix,
a first type of borides comprising one or both of M₂B and M₃B₂, wherein M comprises one or both of Mo and W,
a second type of borides comprising one or both of Cr₂B and (Fe,Cr)₂B, and
one or more other phases other than a martensite and the first and second types of borides and having a hardness greater than 1000 HV, wherein the one or more other phases is present in the coating in an amount less than about 10 mole %.

3. The feedstock material claim 2, wherein the coating comprises less than about 10 mole % of hypereutectic hard phases.

4. The feedstock material of claim 2, wherein the coating comprises between about 5 and 50 mole % of a combined amount of the first type of borides, the second type of borides, and the one or more other phases.

5. The feedstock material of claim 2, wherein the coating comprises less than about 1 mole % of primary carbides.

6. The feedstock material of claim 2, wherein the feedstock material comprises a powder.

7. The feedstock material of claim 2, wherein the feedstock material comprises a wire.

8. The feedstock material of claim 7, wherein the wire comprises a flux core wire or a metal core wire.

9. The feedstock material of claim 2, wherein the coating comprises between about 5 and 50 mole % of the first type of borides.

10. The feedstock material of claim 2, wherein the coating comprises between about 5 and 50 mole % of the second type of borides.

11. The feedstock material of claim 2, wherein the one or more other phases comprise one or both of M₂₃(C,B)₆ and M₇C₃.

12. A method of forming a hardfacing coating onto a substrate, the method comprising:
providing a feedstock material, wherein the feedstock material comprises:
Fe;
B: about 7.5 wt. % to about 8.8 wt. %;
C: about 0.1 wt. % to about 1.0 wt. %;
Cr: about 18 wt. % to about 26 wt. %;
Mo: about 17 wt. % to about 25 wt. %; and
applying the feedstock material to the substrate to form the coating, wherein the coating comprises:
a martensitic matrix,
a first type of borides comprising one or both of M₂B and M₃B₂, wherein M comprises one or both of Mo and W,
a second type of borides comprising one or both of Cr₂B and (Fe,Cr)₂B, and
one or more other phases other than a martensite and the first and second types of borides and having a hardness greater than 1000 HV, wherein the one or more other phases is present in the coating in an amount less than about 10 mole %.

13. The method of claim 12, wherein the feedstock material comprises a powder.

14. The method of claim 12, wherein the feedstock material comprises a wire.

15. The method of claim 14, wherein the wire comprises a flux core wire or a metal core wire.

16. The method of claim 12, wherein applying the feedstock to the substrate comprises thermal spraying the feedstock material to the substrate.

17. The method of claim 12, wherein applying the feedstock to the substrate comprises bulk welding the feedstock material to the substrate.

18. A feedstock material, comprising:
Fe;
B: about 7.5 wt. % to about 8.8 wt. %;
C: about 0.1 wt. % to about 1.0 wt. %;
Cr: about 18 wt. % to about 26 wt. %; and
Mo: about 17 wt. % to about 25 wt. %;
wherein the feedstock material is configured to form an alloy, the alloy comprising:
a martensitic matrix,
a first type of borides comprising one or both of Mo and W, wherein the first type of borides make up between about 5 and about 50 volume % of the alloy,
a second type of borides comprising one or both of Fe and Cr, wherein the second type of borides make up between about 5 and about 50 volume % of the alloy, and
one or more other phases other than a martensite and the first and second types of borides and having a hardness greater than 1000 HV, wherein the one or more other phases is present in the alloy in an amount less than about 10 volume %.

19. The feedstock material of claim 18, wherein the alloy comprises between 15 and 55 volume % of a combined volume of the first type of borides, the second type of borides, and the one or more other phases.

20. The feedstock material of claim 18, wherein the alloy comprises less than about 20 volume % of hypereutectic hard phases.

21. The feedstock material of claim 18, wherein the feedstock material comprises a powder.
